(19) United States
(12) Patent Application Publication
(10) Pub. No.: US 2023/0153770 A1
(43) Pub. Date: May 18, 2023

(54) DIGITAL CURRENCY

(71) Applicants: Mohammed Ismael TATAR, Kanata (CA); Charles Albert RIFICI, Ottawa (CA)

(72) Inventors: Mohammed Ismael TATAR, Kanata (CA); Charles Albert RIFICI, Ottawa (CA)

(21) Appl. No.: 17/987,606

(22) Filed: Nov. 15, 2022

Related U.S. Application Data
(60) Provisional application No. 63/280,815, filed on Nov. 18, 2021.

(51) Int. Cl. G06Q 20/06; G06Q 20/04

(52) U.S. Cl. CPC G06Q 20/065; G06Q 20/0457

(57) ABSTRACT

A non-transitory computer readable medium includes a token space of a first quantity of memory locations representing a maximum number of tokens of a user and the token space is stored on a compute/storage node. An ID space of a second quantity of memory locations representing a number of active tokens of a user, is also included where the second quantity is less than the first quantity and the ID space being stored on the compute/storage node. Each token is a digital currency with a predetermined fiat currency value. Each token has a token ID formed from a personal ID of the user and a value associated with the memory location in the ID space of the token in order that the token ID is a unique value.

### CROSS-REFERENCE TO RELATED APPLICATIONS

This application claims priority to U.S. Provisional Patent Application No. 63/280,815 filed Nov. 18, 2021, which is incorporated herein by reference in its entirety.

### FIELD OF THE INVENTION

The present invention pertains to the field of digital currencies and in particular, to a token-based digital currency mapped to a fiat currency.

### BACKGROUND

In recent years, digital currencies such as crypto currencies have been developed to overcome limitations of fiat currencies used in countries around the world. Perhaps the best known digital currency is Bitcoin. Bitcoin makes use of blockchain technology which includes a back-linked chain of blocks, a public distributed ledger, and consensus mechanism to help ensure the veracity of the data. In order to add new data to the blockchain, new blocks must be “mined” by nodes computing an increasingly difficult mathematical calculation. Bitcoin and other digital currencies have the advantage of being decentralized, without a central bank or a single administrator controlling the issuing or use of the currency.

However, Bitcoin and other digital currencies suffer from several drawbacks. Their price is subject to high degrees of speculation and their exchange rate to fiat currencies can experience wild fluctuations quickly. The mining process consumes a large amount of power which is environmentally unfriendly. Finally, the increasing difficulty of the mathematical calculation means that transactions can only be committed to the distributed ledger at a slow rate.

Therefore, there is a need for an improved digital currency that overcomes the shortcomings of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a digital currency, together with methods and apparatus to create, assign, transfer, and otherwise utilize the digital currency. The currency is implemented using digital tokens with a value that is directly mapped to a fiat currency. Tokens are generated, transferred, or exchanged without the use of mining activities. Each token is associated with a unique, global ID. Each subscriber also has a unique passcode used to interact with the system.

In accordance with an embodiment of the present invention, there is provided a non-transitory computer readable medium including a token space of a first quantity of memory locations representing a maximum number of tokens of a user where the token space being stored on a compute/storage node. Also included is an ID space of a second quantity of memory locations representing a number of active tokens of a user where the second quantity is less than the first quantity. The ID space is also stored on the compute/storage node. Each token has a token ID formed from a personal ID of the user and a value associated with the memory location in the ID space of the token. The token ID is a unique value.

In further embodiment, each token is a digital currency with a predetermined fiat currency value.

In further embodiments, the token ID is a hash of the personal ID of the user and the value associated with the memory location in the ID space of the token.

In accordance with an embodiment of the present invention, there is provided an apparatus including a processor and a non-transitory machine readable medium storing instructions when executed by the processor configuring the apparatus to execute steps of allocating a token space in a first quantity of memory locations representing a maximum number of tokens of a user where the token space is stored on a compute/storage node. Also, allocating an ID space in a second quantity of memory locations representing a number of active tokens of a user where the second quantity is less than the first quantity. The ID space is also stored on the compute/storage node. Then, receiving a personal identifier of the user and combining it with a value associated with the memory location in the ID space of a token of the user to produce a token ID and setting an indicator in the ID space associated with the token and storing the token ID in token space associated with the token.

In further embodiments, the token is a digital currency with a predetermined fiat currency value.

In accordance with an embodiment of the present invention, there is provided an apparatus including a processor and a non-transitory machine readable medium storing instructions when executed by the processor configuring the apparatus to execute steps of receiving a transfer request of a token to a server. Also, sending a confirmation request to an owner of the token to confirm the transfer of the token, evaluating a secondary hash value representing a location of the token, disabling the token in an ID space of the owner, enabling the token in an ID space of a recipient of the token, and generating a new token ID using a personal identifier of the recipient and combining it with a value associated with the memory location in the ID space of the recipient.

In further embodiments, the token represents a digital currency with a predetermined fiat currency value.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 provides a view of a digital platform for implementing the methods described herein, according to an embodiment.

FIG. 2 provides an overview of a structure of tokens and how they are created and stored, according to an embodiment.

FIG. 3 illustrates a method to generate tokens, according to an embodiment.

FIG. 4 illustrates a process to transfer tokens, according to an embodiment.

FIG. 5 illustrates messages required for the transfer of tokens, according to an embodiment.

FIG. 6 illustrates a token ID space utilizing the enable/disable bitmap, according to an embodiment.

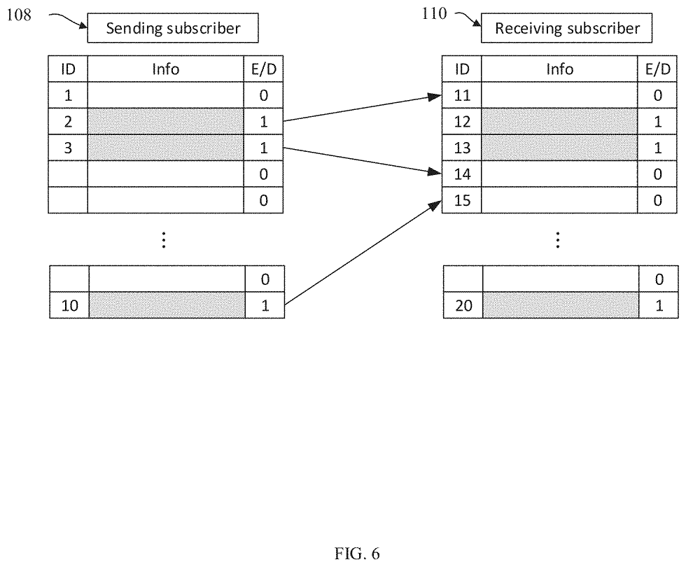

FIG. 7 illustrates inputs and the outputs of the ecosystem that creates and maintains the digital tokens, according to an embodiment.

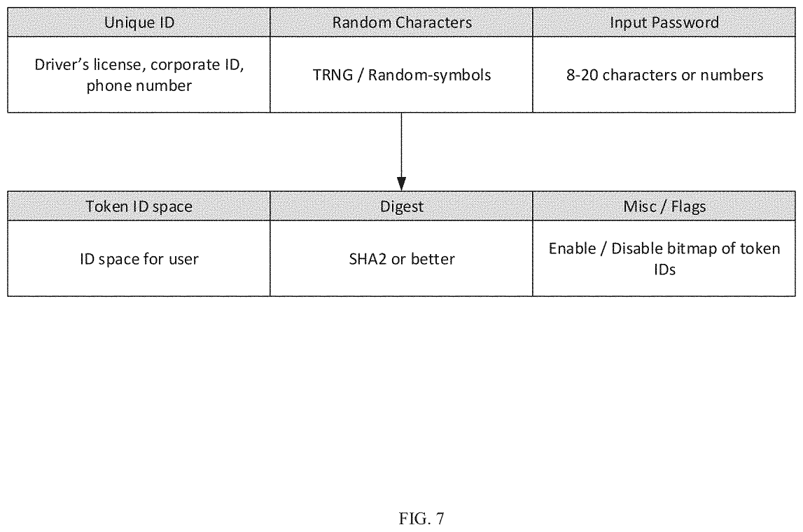

It will be noted that throughout the appended drawings, like features are identified by like reference numerals.

### DETAILED DESCRIPTION

Embodiments of the present invention provide a digital currency, together with methods and apparatus to create, assign, transfer, and otherwise utilize the digital currency. The currency is implemented using digital tokens with a value that is directly mapped to a fiat currency. Tokens are generated, transferred, or exchanged without the use of mining activities. Each token is associated with a unique, global ID. Each subscriber also has a unique passcode used to interact with the system.

In embodiments, the value of a token is based on a fiat currency. A value of fiat currency is initially deposited by a subscriber or on a subscriber's behalf. The subscriber may then receive a sum of tokens that is a multiple of the value of the deposited funds. For example, 1,000 tokens for each USD1. The exchange rate of fiat currency to digital currency token is configurable. Further, different types of tokens based on their ratio (1:N1, 1:N2, 1:N3, etc.) relative to their base fiat currency, for example USD, may also be used.

Digital tokens provide increased spending flexibility and ease of use. For example, when entering a poker tournament, a player may purchase 50,000 chips with a $100 buy in fee. The flexibility to utilize a large number of chips allows the player to play many more hands using the 50,000 chips based on a digital currency than with $100 worth of chips based on a fiat currency. This same example can be easily applied to any online purchases using Amazon, air miles type of reward systems, and other applications that don't use fiat currency for purchasing. Other applications for token based digital currencies include casinos. Today, each casino has unique chips that can only be used in that particular casino. With the universal tokens multiple casinos can accept the same digital currency token and increase their aggregate customer base. Service providers who convert between digital currency tokens and fiat currencies may optionally hold the fiat currency value of the generated tokens using a fund. This fund can be invested by the service provider to help fund the required software and infrastructure or it can be simply held at present value for future conversions. A main source of income for the digital currency service provider may be transaction fees from purchasing and selling tokens. Transaction fees may be charged for token purchase and conversion to currency, as well as for transfers between subscribers.

Embodiment may be applied to many data storage or data processing applications and can be generalized beyond digital currency or digital tokens. Embodiments contained herein may be applied to secure data storage and secure transaction applications.

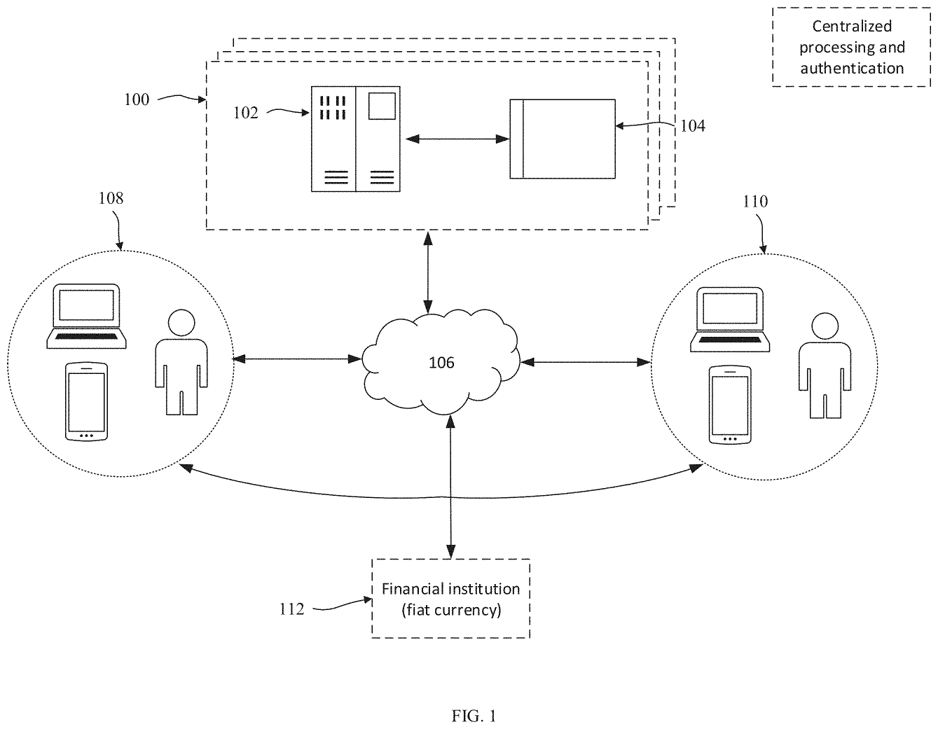

FIG. 1 illustrates a system to implement a digital currency as described herein, according to an embodiment. Tokens are stored, processed, and authenticated in one or more distributed data centers 100 that include one or more servers 102 and storage 104 which may be individually or collectively referred to as compute/storage nodes, as used herein. The data centers 100 may be located in a large or small geographic area as required. Servers 102 may be real or virtual servers and may be owned by a digital currency service provider including central banks and may be accessed through networks 106 including any variety of wired and wireless networks. Storage 104 may include databases or other storage infrastructure to provide adequate response times and redundancy for token-based activities. Compute/storage nodes (servers 102 or storage 104) may be primarily or partially located in cloud computing centers. Depending on the size of the system and the number of transactions and traffic involved, there might be a need for distributed data centers with distributed compute and storage nodes that handle the required processing. Network 106 may include public networks in which case the data transfers may include various security infrastructure and protocols such as VPNs/IPSec, Application Security (TLS), or RSA/DH type key exchanges.

In embodiments, multiple users or subscribers such as a first subscriber 108 and a second subscriber 110 access the system through network 106 using any combination of one or more computing devices such as a smartphone, tablet, laptop computer, desktop computer, etc. Financial institutions, exchanges, and other organizations 112 can also participate in the system to provide conversions between fiat currencies and digital currencies. The digital currency platform includes software such as apps, digital wallets, applications, websites, etc. where subscribers (individuals, merchants, or corporations) can sign in and create an account using a credit card or other forms of money transfers (an e-transfer or bank transfer, digital wallets, etc.).

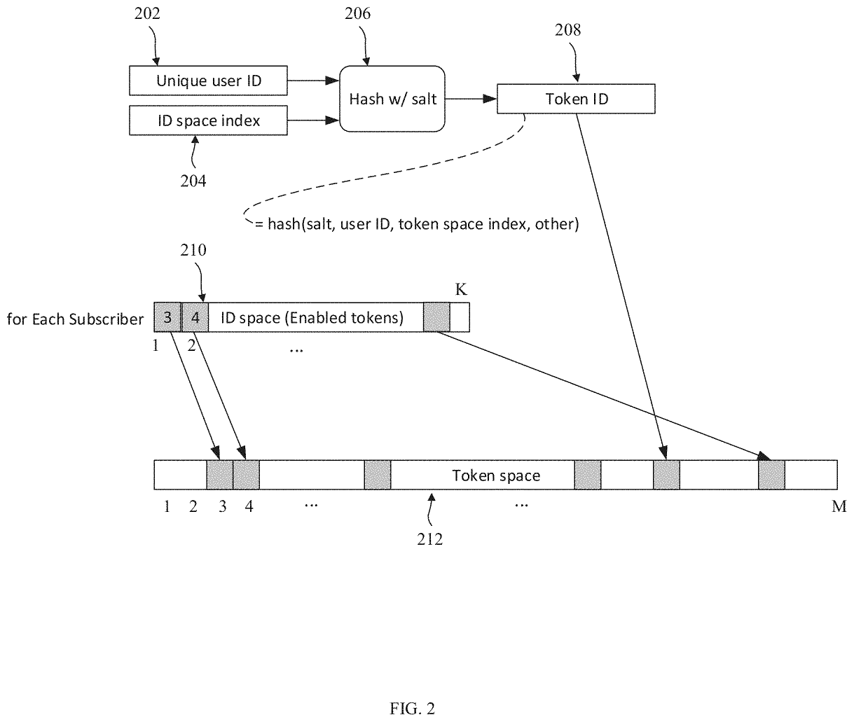

With reference to FIG. 2, each individual, organization, financial institution, or other participant using the digital currency signs up to use digital tokens and is assigned a unique token space 212 and a unique ID space 210. The token space 212 is a maximum number of tokens a subscriber may use and is allocated by a server 102 when the subscriber account is first created. In embodiments, each token space 212 has M entries, where M is a number sufficiently larger than the number of tokens that a subscriber will use, for example, 1 trillion. Each subscriber gets a Token space with M entries. In embodiments, the value of M is sufficiently large to represent the maximum number of tokens a subscriber can ever hold in a lifetime.

The ID space 210 is the number of tokens, K, being used or purchased by a subscriber at a particular point in time. The value of K is much less than the value of M and may be changing (increasing or decreasing) periodically based on the subscriber transactions. Each position in the ID space is used to indicate the location of the active token in the token space. As M>>K, ID space positions may be mapped to many different token space positions (as long as they are not occupied or more specifically not enabled). In embodiments, each position in the ID space may be mapped randomly (with periodic redistribution) or in a configurable-fixed fashion (in a protected memory area) to the token space which provides enhanced security since the token ID is based on the position of the token in the token space 212 and hence will be more difficult to decipher. In other words, reproducing a hash based on an unknown mapping in token space 212 is exceedingly difficult. Further, the distribution of the tokens into token space can be sparse and relies on a bitmap, hence it does not necessarily need to be contiguous or require garbage collection to reorganize. The above approach provides enhanced security since a hacker to the system does not know which ID space position is mapped to which token space position.

Positions in ID space 210 are mapped to positions in token space 212 using fixed or random values inside the entries of 210 that correspond to locations in 212. The addition of the indirection makes an attack based on a malicious token hash replication more difficult. The random mapping may be based on a RNG that selects a value between 1 and M for each subscriber space. If the selected entry in occupied (enable bit is set) then the RNG will try again until it finds an empty slot with the token space structure. Further, for added protection, random locations may be periodically reassigned within the token space structure (reshuffle the token locations and recalculate the token ID based on a configurable period that is selected for optimal efficiency of the compute power or transaction/sec rate of the ecosystem).

In embodiments, each active token space position includes a token ID which includes a subscriber specific portion and a portion based on the token's position in the token space (the ID space). The subscriber specific portion, a user ID 202, may be a unique identifier of a subscriber. Each subscriber of the digital currency has a unique identifier. In embodiments, a 73-bit subscriber identifier allows for over 7 billion unique subscribers to be registered in the system. In other words, the token ID=hash (salt, user ID, [1, 2, . . . , M], optional Subscriber Password Digest or value). The subscriber password digest may be the digest of a salted hash of the subscriber password which is stored in the system (versus storing the actual subscriber password).

A hash may be calculated using the user ID 202 combined with the token's position to create each token ID. For increased security a salted hash may also be used. In this way, each token is unique to the subscriber that owns it. Security may be further enhanced using a randomly changing or configurable-fixed mapping that is only visible to the administrator of the digital currency system. When a transfer happens the ID of the tokens in question is changed to the receiver ID space (once the transaction is confirmed) and a new token ID is generated.

In embodiments, subscriber and token information is transferred over communications network 106 and may use encryption and security features for data transfer when used with a distributed data center model.

In embodiments, all user spaces and memory addresses are protected from other users at boot time and during runtime. Further software security features such as Secure Boot may also be required.

FIG. 2 provides an overview of a structure of tokens and how they are created and stored, according to an embodiment. The tokens are created with a value based on any fiat currency or other coupon with a fixed fiat currency value. Tokens are stored in secure data centers under the control of the service provider of the digital currency. Subscribers access the system through an electronic device such as a smartphone, tablet, laptop, computer, terminal, etc. using a web browser, app, application, etc. and may see the token balance. Tokens can be transferred to other subscribers for transactions or can be turned back into fiat currency using the app or the web site. Transaction fees may be applied for exchanges of tokens to and from fiat currencies and potentially for peer-to-peer transfers directly between subscribers.

In embodiments, each token is generated by the digital currency service provider using a hybrid centralized and distributed processing model with each token receiving a unique identification code or number (referred to herein as an ID). Once created, a token may be securely assigned or transferred to the owner. The process of creating new tokens does not require a “mining” process as is required by other crypto-currency systems known in the art. Blockchain technology with a linked list of blocks and distributed ledger is also not required for operation of the digital currency system.

In embodiments, each token has a unique ID based on a user ID of the subscriber owning the token. The user ID used to generate a token ID may be based on a personal identifier of the subscriber such as a credit card number, unique personal ID, a country, region, or city codes, etc.

The digital currency service provider uses a hybrid centralized and distributed processing model where authentication functions are centralized, while the transfer of tokens and exchanges between tokens and fiat currency is centralized or distributed. Updating the bitmaps associated with the subscriber ID space 210 and token space 212 may be done in a distributed fashion at the end points, may be centralized similar to authentication functions, or may be done using a combination of both methods.

In embodiments, the token space 212 may be based on blocks to reduce the complexity of the implementation and reduce the required processing power to administer the system. Further, as another level of protection for transactions involving moving large number of tokens between subscribers, another hash on the tokens being transferred may be introduced (cumulative hash of the token ID's being transferred) which can be checked (as a special code or QR code that the sender enters) before moving the tokens to the user space of the receiving subscriber. It is important to realize that the sender tokens selected for transfer can be either randomly chosen (or fixed based on increasing/decreasing location) from the sender's active tokens space (entries in the range of 1 to M with enable bits set). This provides added level of security on the cumulative hash.

When tokens are transferred to the receiver, the sender tokens in question will have their bitmaps set to disable while the receiver bitmaps of those tokens will be enabled. The location of the receiver tokens can be either randomly selected using a RNG that finds non-occupied locations within the receiver's token space or it can be mapped to pre-allocated (or newly allocated) empty regions within the receiver token space.

Note, encryption within the ecosystem in FIG1, may be used both in transit and at rest to protect important user information.

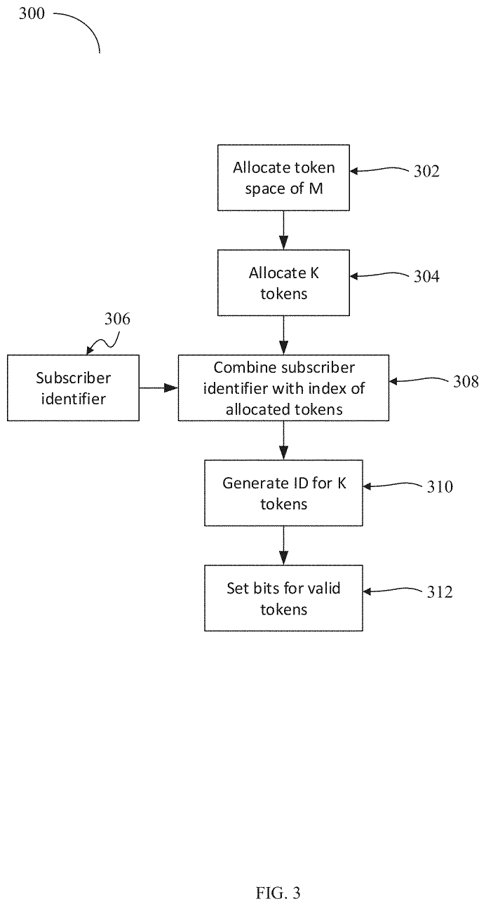

FIG. 3 illustrates a method to generate tokens, according to an embodiment. In step 302 a token space 212 of dimension M is allocated. In step 304 K tokens are initially allocated in an ID space 210 of a user and associated with the user's user ID. In step 306, a subscriber/user identifier (ID) 202 is receive and in step 308 the subscriber ID 202 and a value 204 such as an index of the allocated tokens in the ID space 210 or the token space 212 is combined using hashing techniques or hashing and salting techniques 206. In step 310, token IDs 208 are generated. In step 312, enabled tokens are indicated in the ID space 210. In embodiments, enabled tokens are set by setting bits in a bitmap of the token space 212.

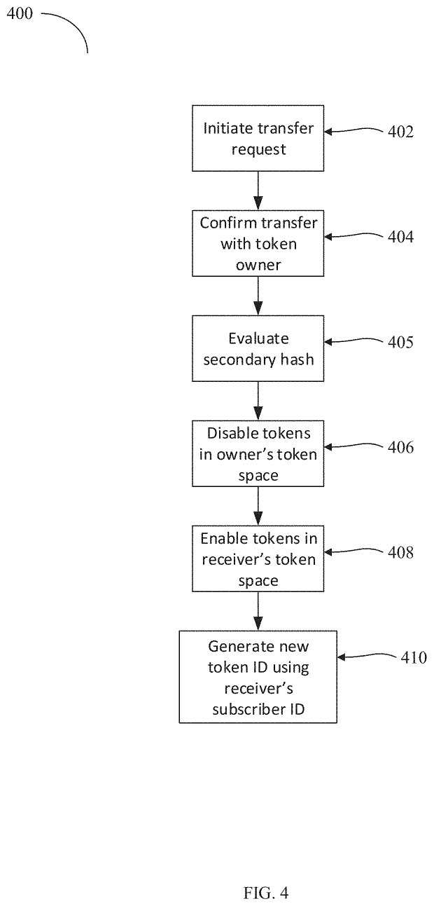

FIG. 4 illustrates a process to transfer tokens, according to an embodiment. Methods to transfer tokens are done in a simple and secure fashion. Each token is originally owned by the purchaser unless transferred using the methods as described herein. Transfers of token may be performed by transferring the original token ID to the receiver's ID space. The transfer requires the sender's password and the sender's acknowledgement for dual protection which may be done by a variety of methods such as by using email or text verification. The physical aspect of the token transfer happens using a bitmap that enables the ID space 210 entries of receiver's token space and disables the corresponding bitmap in the sender's ID space. In embodiments, the transfer involves a handshake where the owner shares a unique passcode (such as a card tap, or private pin, QR code, special code, etc.) with the receiver and then the owner accepts the transaction (after receiving an email or text) when the receiver is ready to receive the tokens.

In embodiments, token IDs may be salted using methods such as TRNG, Random Char, etc., and hashed using SHA2 or better methods. Only the digest is stored. When a user transfers tokens, they enter their password (which is salted and hashed and compared to the digest) then the receiver asks the sender if they want to transfer the specified number of their tokens. Once the sender acknowledges the transfer (ACKs), the ID of the tokens in question are replaced by the receiver's ID. For example, a customer comes to a casino and wants physical casino chips using his tokens. The cashier has a machine similar to a debit card reader which the player taps a card which contains his or her token passcode to confirm the transaction then enters the number of tokens to spend. The receiver can then reclaim those tokens and replace their ID with the casino ID to complete the transfer. Later, the player may come back with more chips (after playing and winning) and may want to cash out. The cashier takes the casino chips and does a token transfer for the required number of tokens from the casino ID to the user ID of the player. The player can confirm the balance of his or her tokens using an app or website.

In step 402, a transfer request is initiated. The request may be initiated by an owner of a token, a recipient of a token, a third party, or another stakeholder. In step 404, the present owner of the token authenticates with an authentication server and confirms the transfer. In step 405, a secondary hash value is evaluated. This secondary hash value may be the cumulative hash of all the sender token ID values corresponding to the tokens being transferred to the receiver. In step 406, the tokens to be transferred are disabled in the ID space 210 of the owner. In step 408 equivalent tokens are enabled in the ID space 210 of the recipient. In step 410, new token IDs are generated using the receiver's user or subscriber ID and the receiver's space ID mapping.

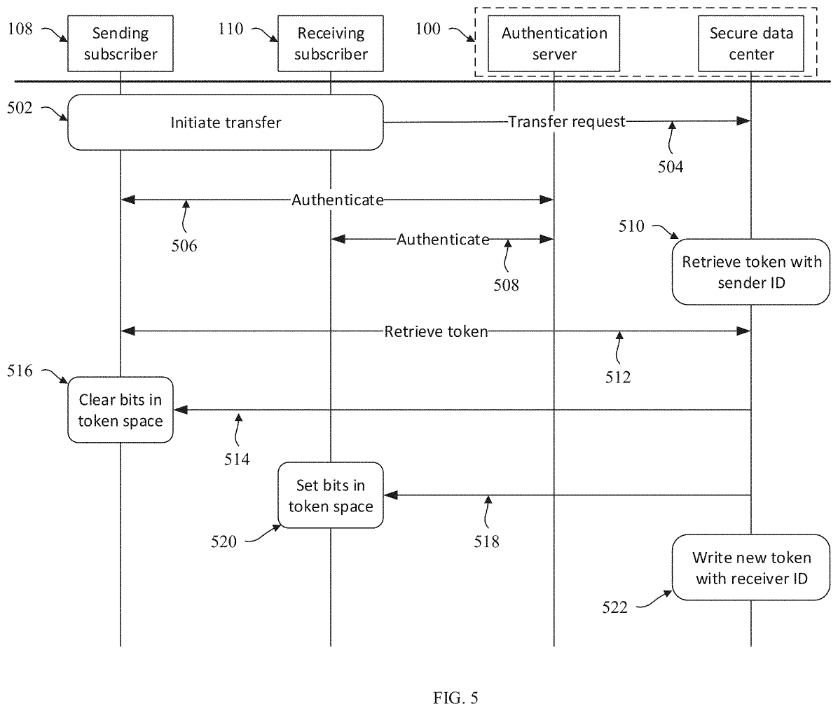

FIG. 5 illustrates messages required for the transfer of tokens, according to an embodiment. Sending subscriber 108 or receiving subscriber 110 may initiate a token transfer 502 by sending a transfer request 504 to a secure data center 100. Sending subscriber 108 authenticates 506 with the authentication server in the secure data center 100. Receiving subscriber 110 also authenticates 508 with the authentication server in the secure data center 100. Once authentication is completed, in 510 the secure data center retrieves the token(s) to be transferred. The tokens have token IDs that include the sending subscriber's user ID. A handshaking protocol based on the retrieved token 512 may then be conducted and the sending subscriber 108 is then instructed to clear bits 516 in its token space. A message 518 is also sent to the receiving subscriber 110 to set bits 520 in its token space. Finally, a new token ID, based on a user ID of the receiving subscriber 110 is written at the secure data center.

In embodiments a distributed approach to token transfer may be used where the change of ID processing happens at the receiver end.

In embodiments, a hash (SHA2 or better) is generated for the token ID and subscriber password. Random characters might be added before the hash is generated. The digest or fingerprint for the token is used for storage and transfer purposes. The password digest is used for authentication at future logins. For added security, an additional hash of the token IDs of the tokens being transferred may be done and checked at the receiver end as part of completing the transfer before those tokens get mapped to the receiver space.

Through the descriptions of the preceding embodiments, the present invention may be implemented by using a combination of hardware and software. The hardware component may be any type of universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations, or equivalents that fall within the scope of the present invention.

What is claimed is:

1. A non-transitory computer readable medium comprising:
a token space of a first quantity of memory locations representing a maximum number of tokens of a user, the token space being stored on a compute/storage node;
an ID space of a second quantity of memory locations representing a number of active tokens of a user, the second quantity being less than the first quantity, the ID space being stored on the compute/storage node;
wherein each token having a token ID formed from a personal ID of the user and a value associated with the memory location in the ID space of the token, the token ID being a unique value.

2. The non-transitory computer readable medium of claim 1 wherein the token ID is a hash of the personal ID of the user and the value associated with the memory location in the ID space of the token.

3. The non-transitory computer readable medium of claim 1 further comprising a mapping of each of the second quantity of memory locations to one of the first quantity of memory locations.

4. The non-transitory computer readable medium of claim 3 wherein the mapping of each of the second quantity of memory locations is to a random one of the first quantity of memory locations.

5. The non-transitory computer readable medium of claim 1 wherein each token is a digital currency with a predetermined fiat currency value.

6. An apparatus comprising:
a processor; and
a non-transitory machine readable medium storing instructions when executed by the processor configuring the apparatus to execute steps of:
allocating a token space in a first quantity of memory locations representing a maximum number of tokens of a user, the token space being stored on a compute/storage node;
allocating an ID space in a second quantity of memory locations representing a number of active tokens of a user, the second quantity being less than the first quantity, the ID space being stored on the compute/storage node;
receiving a personal identifier of the user and combining it with a value associated with the memory location in the ID space of a token of the user to produce a token ID; and
setting an indicator in the ID space associated with the token and storing the token ID in token space associated with the token.

7. The apparatus of claim 6 wherein the processor is further configured to execute the steps of mapping of each of the second quantity of memory locations to one of the first quantity of memory locations.

8. The apparatus of claim 7 wherein the mapping of each of the second quantity of memory locations is to a random one of the first quantity of memory locations.

9. The apparatus of claim 8 wherein the token is a digital currency with a predetermined fiat currency value.

10. An apparatus comprising:
a processor; and
a non-transitory machine readable medium storing instructions when executed by the processor configuring the apparatus to execute steps of:
receiving a transfer request of a token to a server;
sending a confirmation request to an owner of the token to confirm the transfer of the token;
evaluating a secondary hash value representing the group of the tokens being transferred;
disabling the token in an ID space of the owner;
enabling the token in an ID space of a recipient of the token; and
generating a new token ID using a personal identifier of the recipient and combining it with a value associated with the memory location in the ID space of the recipient.

11. The apparatus of claim 10 wherein the processor is further configured to execute the steps of mapping of each of the second quantity of memory locations to one of the first quantity of memory locations.

12. The apparatus of claim 11 wherein the mapping of each of the second quantity of memory locations is to a random one of the first quantity of memory locations.

13. The apparatus of claim 10 wherein the token represents a digital currency with a predetermined fiat currency value.
